(19) United States
(12) Patent Application Publication
(10) Pub. No.: US 2016/0163492 A1
(43) Pub. Date: Jun. 9, 2016

(54) DETECTOR AND METHOD FOR DETECTING ULTRAVIOLET RADIATION

(71) Applicant: CERN - EUROPEAN ORGANIZATION FOR NUCLEAR RESEARCH, Geneva 23 (CH)

(72) Inventors: Philippe Breuil, Sorbiers (FR); Vladimir Peskov, Meyrin (CH); Paolo Martinengo, Prevessin-Moens (FR)

(73) Assignee: CERN - EUROPEAN ORGANIZATION FOR NUCLEAR RESEARCH, Génèva 23 (CH)

(21) Appl. No.: 14/908,893

(22) PCT Filed: Jul. 31, 2013
(86) PCT No.: PCT/EP2013/002274

§ 371 Date: Jan. 29, 2016

(51) Int. Cl. H01J 1/34; H01J 1/78; G08B 17/12; G01J 1/42

(52) U.S. Cl. CPC H01J 1/34; G01J 1/429; H01J 1/78; G08B 17/12

(57) ABSTRACT

An electron filtering layer placed on a photocathode of a UV light detector allows to selectively filter out electrons generated from a photoconversion of long wavelengths. The filter may be tuned by selecting the material and the thickness of the electron filtering layer. By means of the filtering layer, background noise due to visible parts of the spectrum may be efficiently suppressed. Applications of the invention include a solar-blind flame and/or smoke detector.

### FIELD OF THE INVENTION

The invention relates to a detector for ultraviolet radiation and a corresponding detection method, in particular for applications to the detection of flame and smoke.

### BACKGROUND AND STATE OF THE ART

Ultraviolet light sensors have manifold applications ranging from the detection of counterfeit money and spark and corona visualization devices to detectors for smoke and flames. Due to the emission from CH and OH molecular bands, flames in air emit strongly in the wavelength interval 185 nm to 280 nm. The operation principle of UV flame sensors is based on the fact that the sunlight in the wavelength interval 185 nm to 280 nm is almost fully absorbed by ozone in the upper layer of the atmosphere, while on the ground level air is transparent for these wavelength ranges. This allows to detect flames by means of the emitted ultraviolet light even in the presence of a strong background from the sun or from light sources generating visible light.

Most commercially available UV flame detectors make use of the photoelectric effect for the detection of UV light. These detectors comprise a metallic photocathode in which incident UV photons are converted into electrons according to Einstein's equation h·ν=φ+Eₖ, wherein h denotes Planck's constant, ν is the frequency of the incident UV light, φ is the work function and represents the energy required to remove a delocalized electron from the surface of the metal, and Eₖ denotes the maximum kinetic energy of the emitted photoelectrons. The emitted photoelectrons can be collected on a readout pad, and their analysis allows to detect the incident UV light. The most sensitive commercially available UV flame detectors (the so-called EN 54-10 Class-1) can detect a 30 cm×30 cm×30 cm flame from a distance of around 20 m in about 20 seconds.

Avalanche gaseous detectors filled with photosensitive gases can detect UV photons with a much higher sensitivity. In these detectors, the UV radiation from flames causes photo ionization of vapors with small ionization potentials, and the generated photoelectrons drift to the amplification structure where they initiate an electron avalanche, as described in J. M. Bidaut et al., NIMA580 (2007) 1036. Detectors of this type are useful for indoor applications. However, their outdoor applications are limited, since at temperatures below zero their sensitivity is significantly reduced due to the condensation of the photosensitive vapors.

There have been some attempts to develop avalanche detectors for outdoor applications using CsI or CsTe photocathodes instead of photosensitive vapors. Detectors of this kind can operate in the temperature interval of −200° C. to +80° C. without a significant degradation of the quantum efficiency, and at the same time are almost 1000 times more sensitive to UV radiation from flames than commercial Class 1 sensors, as reported in L. Periale et al., NIMA572 (2007) 189, and P. Carlson et al., NIMA505 (2003) 207. However, these detectors are very sensitive to radiation with wavelengths λ≧290 nm, where the sun emission is extremely strong. Hence, in direct sunlight these detectors become very noisy, which renders them unsuitable for many outdoor applications.

The background noise induced by the sun can be reduced significantly by using narrow band filters, which suppress long wavelength radiation from the sun. However, the use of filters leads to a significant decrease in the sensitivity, usually by a factor of 10 or even more. As an additional disadvantage, narrow band filters are very expensive, thereby leading to a significant increase of the cost of such a sensor. The cost can be reduced by choosing smaller filters, but this will again impact negatively on the detector sensitivity.

What is required is an improved detector device that is highly sensitive to ultraviolet radiation, can be used in direct sunlight and can be manufactured using well-established fabrication techniques and at low costs.

### OVERVIEW OF THE INVENTION

This objective is achieved by means of a detector device and a detection method with the features of independent claims 1 and 19, respectively. The dependent claims relate to preferred embodiments.

A detector device for detecting ultraviolet radiation according to the present invention comprises a base layer or substrate and a photoconversion layer formed on said substrate, wherein said photoconversion layer is adapted to convert incident ultraviolet radiation into free electrons by means of a photoelectric effect. The detector device further comprises a filtering layer formed on said photoconversion layer, wherein said filtering layer is adapted to selectively filter out electrons from a photoconversion of long wavelength of said incident radiation.

The inventors found that by forming an additional filtering layer on the photoconversion layer, the electrons emanating from a photoconversion of long wavelengths can be efficiently filtered out. This allows to suppress the background signal from the sun or other light sources emitting in the visible or infrared part of the spectrum, and renders the detector device solar-blind. On the other hand, the electrons emanating from a photoconversion of ultraviolet radiation can penetrate from the photoconversion layer through the filtering layer and can be detected. The result is a detector device that is sensitive only to photons in the ultraviolet wavelength range, and provides a very high quantum efficiency for these wavelengths, whereas longer wavelengths are selectively filtered out.

The detector device according to the invention can hence be used as a highly sensitive detector for ultraviolet radiation, such as for flame detection, even in direct sunlight or in other applications with strong background light in the visible or infrared part of the spectrum.

By suitably selecting the properties of the filtering layer, such as the material composition and thickness of the layer, the filtering layer may be tuned to the desired wavelength range. In a preferred embodiment, said filtering layer is adapted to selectively filter out electrons emanating from a photoconversion of said incident radiation of wavelengths higher than a predetermined threshold value.

Above said threshold value, the number of free electrons emanating from said photoconversion layer and being able to penetrate said filtering layer is low. For instance, a threshold value in the sense of the present invention may be understood to be a wavelength value such that a ratio of a number of photoelectrons generated in said photoconversion layer and penetrating said filtering layer and a number of corresponding incident photons of a wavelength higher than said predetermined threshold value is no larger than 10⁻⁶, preferably no larger than 10⁻⁷, and in particular no larger than 10⁻⁸.

The ratio of the number of generated photoelectrons and the number of incident photons generating these photoelectrons is sometimes referred to as the quantum efficiency of the detector device.

At wavelengths in the ultraviolet range, the electrons emanating from the photoconversion can penetrate the filtering layer, and hence the quantum efficiency is high. The threshold in the sense of the present invention can hence also be understood as a wavelength selected such that a ratio of a number of generated free electrons and a number of corresponding incident photons, or quantum efficiency, of a wavelength lower than said predetermined threshold value is no smaller than 10⁻³, preferably no smaller than 10⁻², and in particular no smaller than 10⁻¹.

In a preferred embodiment, said threshold value is no smaller than 250 nm, and preferably no smaller than 270 nm.

In another embodiment of the invention, said threshold value is no larger than 350 nm, in particular no larger than 300 nm.

By tuning the filtering layer to this wavelength range, a high quantum efficiency may be achieved for the wavelength interval between 185 and 280 nm, where flames typically emit, whereas the long wavelengths from the sun or other visible light sources can be efficiently suppressed.

According to Planck's formula E=h·ν, the energy E of the incident light quanta is directly proportional to the frequency ν of the incident light, which is in turn inversely proportional to the wavelength λ. Hence, the characteristics of the filtering layer according to the present invention may alternatively be described in terms of the frequency ν or energy E instead of the wavelength of the incident photons. According to a preferred embodiment, said filtering layer is hence adapted to selectively filter out electrons emanating from the photoconversion of small frequencies or small energies of said incident radiation.

In the photoconversion that takes place in the photoconversion layer, the energy of the incident photons is transformed into kinetic energy of the liberated photoelectrons according to the equation h·ν=φ+Eₖ, wherein φ denotes the work function or electron affinity, which denotes the minimum energy required to remove a delocalized electron from the photoconversion layer, and Eₖ denotes the maximum kinetic energy which an emitted photoelectron may acquire.

The filtering layer may hence alternatively be characterized in terms of the energy of the photoelectrons rather than the incident radiation. In a preferred embodiment, said filtering layer is adapted to selectively filter out electrons emanating from said photoconversion layer with an energy lower than a predetermined threshold value.

Highly efficient photosensitive layers are layers having a small work function or electron affinity. This ensures that the quantum efficiency, and hence the sensitivity of the detector device is high.

Preferably, said filtering layer has an electron affinity that is larger than an electron affinity of the photoconversion layer. Photoelectrons from the photoconversion layer can hence penetrate through the filtering layer and can be detected if the electrons have an energy above the threshold value.

The threshold value of the filtering layer may be tuned to the desired wavelength range by appropriately selecting the thickness of the filtering layer. The optimum thickness may depend on the filtering material.

In a preferred embodiment, said filtering layer is formed at a thickness of no larger than 100 Å, preferably no larger than 50 Å, and in particular no larger than 20 Å. The inventors found that these values provide particularly good results for the example of a KI filtering layer.

The filtering layer can be formed from a semiconductor material, preferably with minimum electron trapping levels. In an alternative configuration, the filtering layer may comprise an ultrathin metallic layer, preferably in the thickness range of no more than 10 Å, in particular no more than 2 Å.

The inventors found that an efficient and highly selective filtering can be achieved with a filtering layer comprising KI and/or NaI and/or ethyl ferrocene (EF).

In a preferred embodiment, said filtering layer is formed directly on said photoconversion layer and/or contacts said photoconversion layer.

Preferably, said photoconversion layer comprises a semiconductor material.

Compared to metals, semiconductor materials have less free electrons in the bulk material, and are hence less susceptible to energy loss due to electron-electron collisions. In semiconductor materials, electron loss is mostly due to phonon scattering in the lattice. The energy loss per interaction is hence much smaller than it is in electron-electron collisions, and thus photoelectrons from deeper regions of the bulk material can reach the surface with an energy above the electron affinity, and can be detected as free electrons.

The inventors have achieved good results with a photoconversion layer comprising an alkali metal halide, in particular CsI, or a photoconversion layer comprising CsTe or SbCs.

In a preferred embodiment, said photoconversion layer has a thickness of at least 200 nm, preferably at least 400 nm.

Preferably, said photoconversion layer has a thickness of no more than 1000 nm, preferably no more than 600 nm.

In an embodiment of the invention, said photoconversion layer is formed with an even or smooth upper surface.

Alternatively, said photoconversion layer may comprise an uneven or structured upper surface.

The inventors have achieved good results and a high selectivity with a columnar surface structure, in which the upper surface of the photoconversion layer comprises pillars or columns protruding from the surface. The filtering layer can be formed on the pillars or columns.

There are standard techniques of producing columnar structures, for example using CsI crystalla.

Said substrate may comprise a metal or may be a metallic substrate.

In a preferred embodiment, said detector device further comprises an electron detection unit adapted to detect and/or analyze said photoelectrons emanating from said photoconversion layer and filtering layer.

Preferably, the detector device comprises an amplification unit adapted to amplify said photoelectrons passing through said filtering layer, in particular by means of an avalanche amplification.

The inventors found that an amplification unit allows to greatly enhance the sensitivity of the detector device.

The inventors have achieved particularly good results with an amplification structure in which throughholes are formed in said substrate, said photoconversion layer, and said filtering layer, said throughholes for amplifying said photoelectrons passing through said filtering layer, in particular by means of an avalanche amplification.

In the art, amplification structures in which amplification takes place in throughholes formed in a thin foil are sometimes known as GEM-type detectors. GEM is an abbreviation for Gas Electron Multiplication, which refers to a detector chamber filled with a photosensitive gas for photoconversion, as described in further detail in J. M Bidaut et al., NIMA580 (2007) 1036. This is how the detector is typically used in applications requiring UV photon detection. However, it is understood that in the context of the present invention photoconversion may take place in the photoconversion layer formed on the substrate, rather than in the gas. Hence, contrary to conventional GEM detectors, the detector device of the present invention does not require a photoconversion gas, and can be operated in many ordinary gas mixtures, including air.

A detector configuration with a GEM-type amplification structure is an independent aspect of the present invention.

In this aspect, the invention is directed at a detector device comprising an amplification structure, said amplification structure comprising a base layer and first and second electrodes extending on opposite first and second surface sides of said base layer, wherein a plurality of through holes extend through said amplification structure. The detector device further comprises a collection anode spaced apart from said amplification structure. Said collection anode may preferably face said second surface side of said base layer.

The detector device according to this aspect may further comprise first voltage means adapted to raise said first electrode to a first potential, second voltage means adapted to raise said second electrode to a second potential higher than said first potential, and third voltage means adapted to raise said collection electrode to a third potential higher than said second potential. A photoconversion layer is formed on said first electrode, said photoconversion layer adapted to convert incident ultraviolet radiation to photoelectrons by means of the photoelectric effect, and a filtering layer formed on said photoconversion layer, said filtering layer being adapted to selectively filter out electrons from a photoconversion of long wavelengths of said incident radiation.

In the sense of the present invention, the first electrode may hence serve as a substrate for the photoconversion layer formed on said electrode, and the filtering layer may be formed on said photoconversion layer.

In an embodiment of the present invention, the detector device comprises a plurality of substrates extending spaced apart from one another, in particular parallel to one another, wherein a photoconversion layer and/or a filtering layer with some or all of the features described above are formed on each said substrate.

A detector device with a plurality of stacked substrates can be operated in cascade mode, and allows to reach high gas gains such that even single photoelectrons can be detected.

In an embodiment of the present invention, throughholes are formed in at least part of said substrates, said photoconversion layers, and said filtering layers.

Preferably, at least part of said throughholes in neighboring substrates are misaligned with respect one another.

In a preferred embodiment, the detector device comprises focusing means for focusing said ultraviolet radiation onto said substrate or photoconversion layer. Said focusing means may comprise a lens and/or a blind.

The focusing means allow to resolve a direction or angle of the incident ultraviolet radiation, and hence facilitate the localization of the source of ultraviolet radiation.

The detector device according to the present invention may be employed for detecting a source of ultraviolet radiation, such as a flame or a corona discharge.

In an alternative configuration, the detector device according to the present invention may be used as a smoke detector adapted to detect a decrease in the amount of incident ultraviolet radiation from a UV light source due to smoke in the light path between the UV light source and the detector device.

In this latter configuration, the detector device may comprise at least one light source emitting ultraviolet radiation, said light source being adapted to emit said ultraviolet radiation towards said substrate. Said device may further comprise an electron detection unit adapted to detect and/or analyze said photoelectrons passing through said filtering layer, and an analyzation unit coupled to said electron detection unit and adapted to derive from said detected electrons a variation in the amount of incident ultraviolet radiation.

The detection device may comprise a plurality of ultraviolet light sources arranged around said detector device. A plurality of UV light sources allow to cover large areas and to detect smoke even when it is located far away from the photoconversion and filtering layer.

The pulse UV light sources may emit ultraviolet light with a predetermined frequency, typically one pulse per min. This allows to distinguish the UV light emanating from the UV light sources from additional UV sources, such as flames or fire that shall be detected. In this configuration, the detector device according to the present invention can be used to detect both fire and smoke.

In a preferred embodiment, the detector device further comprises a vacuum chamber in which said substrate is placed.

It is a particular advantage of the present invention that the detector device does not rely on photoconversion by means of vapors or gases as described in J. M. Bidaut et al., NIMA580 (2007) 1036, and hence can be operated in ambient air or even in vacuum. In a conventional detector device operating with photosensitive gases or vapors, electrons are generated over the entire travel path of the incident light. This leads to a smearing out, and to poor spatial resolution of the source of the incident radiation. In contrast, the detector device according to the present invention allows for a localized photoconversion in the photoconversion layer at those areas of the sensor device that are exposed to incident radiation. The source of the incident radiation can hence be localized with high accuracy, in particular when said detector device is used in conjunction with focusing means such as lenses or blinds.

The invention further relates to the use of a detector device with some or all of the features described above to detect ultraviolet radiation incident on the surface of said device.

Moreover, the invention relates to the use of a detector device with some or all of the features described above to detect fire or smoke from a variation in the amount of ultraviolet radiation incident on a surface of said device.

Other applications of the invention are in the visualization of sparks and coronas, or any other UV visualization in daylight conditions.

The invention also relates to a method for detecting ultraviolet radiation, comprising the steps of providing a substrate, providing a photoconversion layer on said substrate, said photoconversion layer being adapted to convert incident ultraviolet radiation into free electrons by means of the photoelectric effect, and providing a filtering layer formed on said photoconversion layer, said filtering layer being adapted to selectively filter out electrons emanating from a photoconversion of long wavelengths of said incident radiation.

The method further comprises the steps of detecting and/or analyzing said electrons passing through said filtering layer, and determining from said detected electrons the presence of ultraviolet radiation incident onto said substrate.

The filtering layer, photoconversion layer and substrate may be layers with some or all of the features described above.

In a preferred embodiment, the method further comprises a step of amplifying said photoelectrons prior to detecting and/or analyzing said electrons, in particular by means of an avalanche amplification.

Preferably, the method further comprises the step of focusing said ultraviolet radiation onto said substrate.

In a preferred embodiment, the method according to the present invention further comprises the steps of providing at least one light source emitting ultraviolet radiation, said light source being adapted to shine said ultraviolet radiation onto said substrate, and determining from said detected electrons a variation in the amount of incident ultraviolet radiation.

### DESCRIPTION OF PREFERRED EMBODIMENTS

The features and numerous advantages of the detector device and detection method according to the present invention can be best understood from a detailed description of the preferred embodiments with reference to the accompanying drawings, in which:

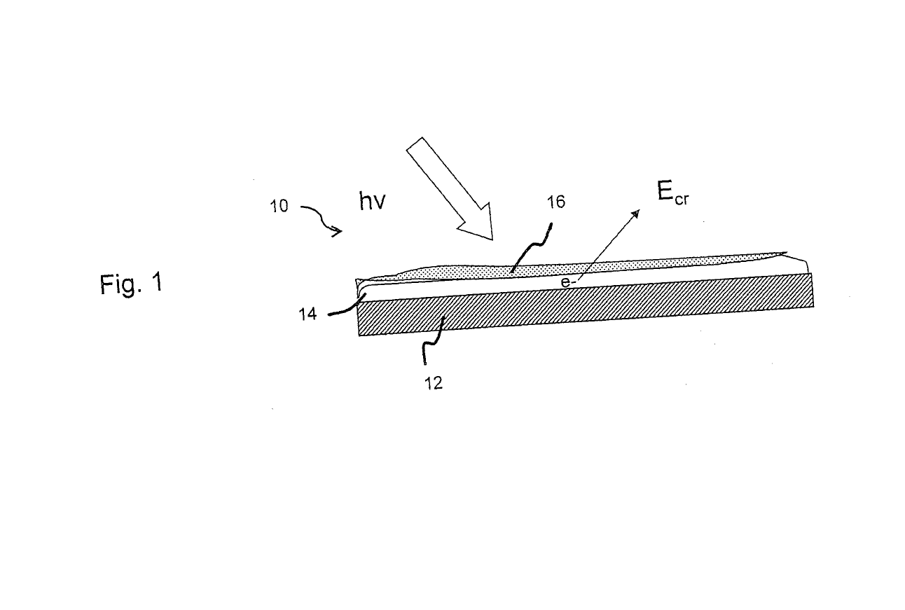

FIG. 1 is a schematic cross-sectional view of a detector device with an electron filtering layer according to an embodiment of the present invention;

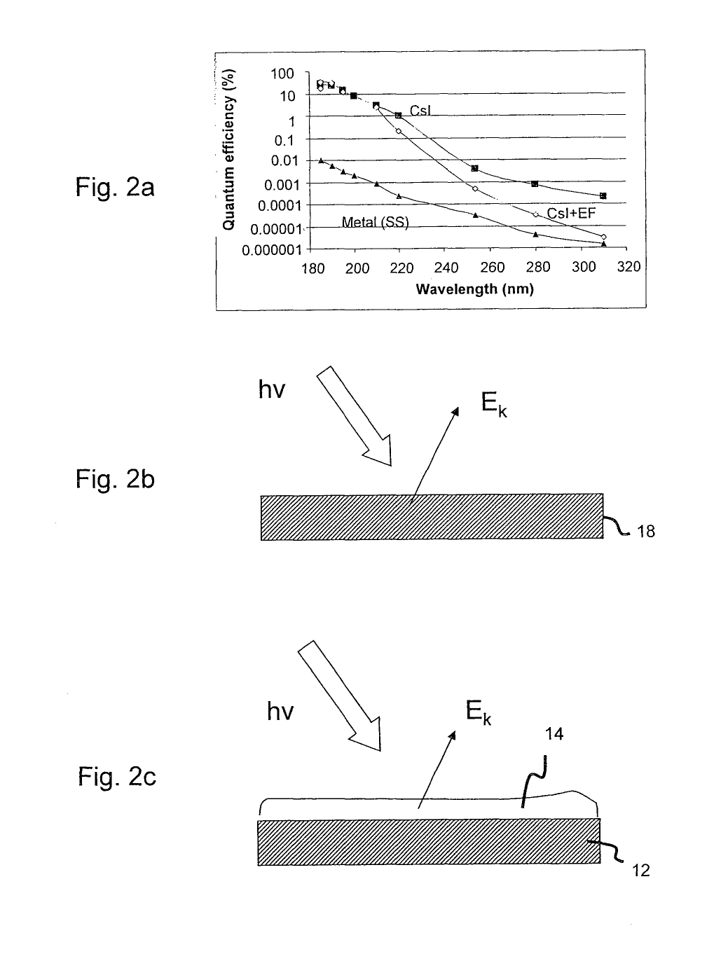

FIG. 2a is a diagram illustrating the quantum efficiency as a function of the wavelength of the incident radiation for a detector device according to the present invention, comprising a filtering layer formed from ethyl ferrocene, and for comparison also shows the quantum efficiency achieved with a photocathode without electron filtering layer and the quantum efficiency achieved with a conventional metallic photocathode;

FIG. 2b is a schematic cross-sectional view of the conventional metallic photocathode used for comparison in the diagram of FIG. 2a;

FIG. 2c is a schematic cross-section of a conventional photocathode without electron filtering layer, which is used for comparison in the diagram of FIG. 2a;

FIG. 2d is another exemplary diagram showing the quantum efficiency of a detector device according to the present invention as a function of the wavelength, but employing KI instead of ethyl ferrocene as a filtering layer;

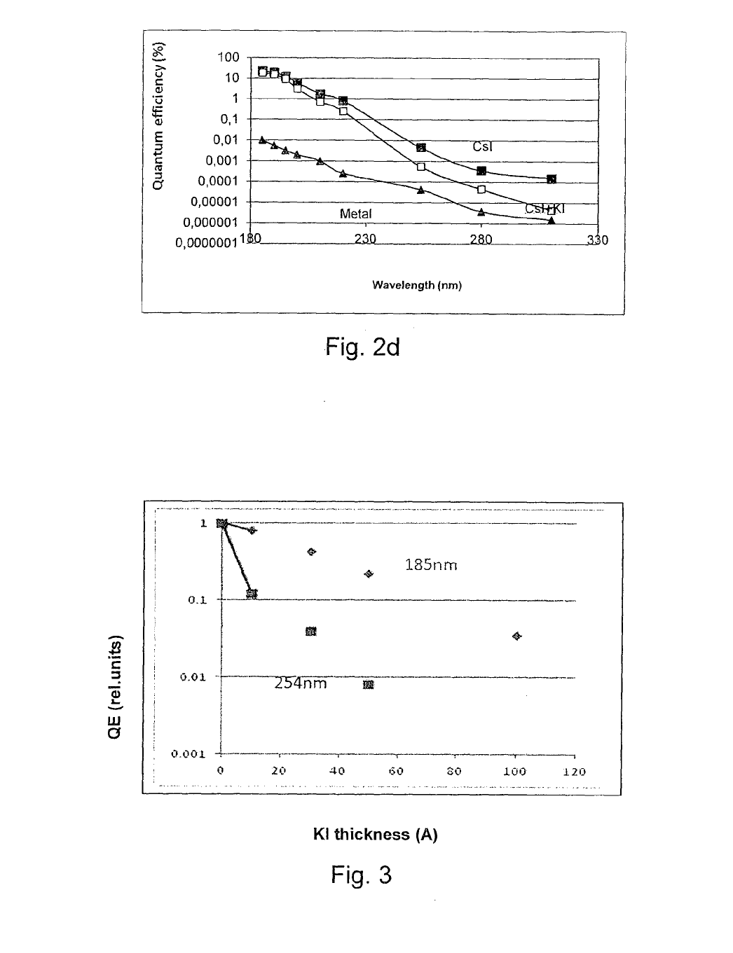

FIG. 3 is a diagram showing the quantum efficiency of a uniform CsI photocathode employing KI as the filtering layer, as a function of the thickness of the filtering layer;

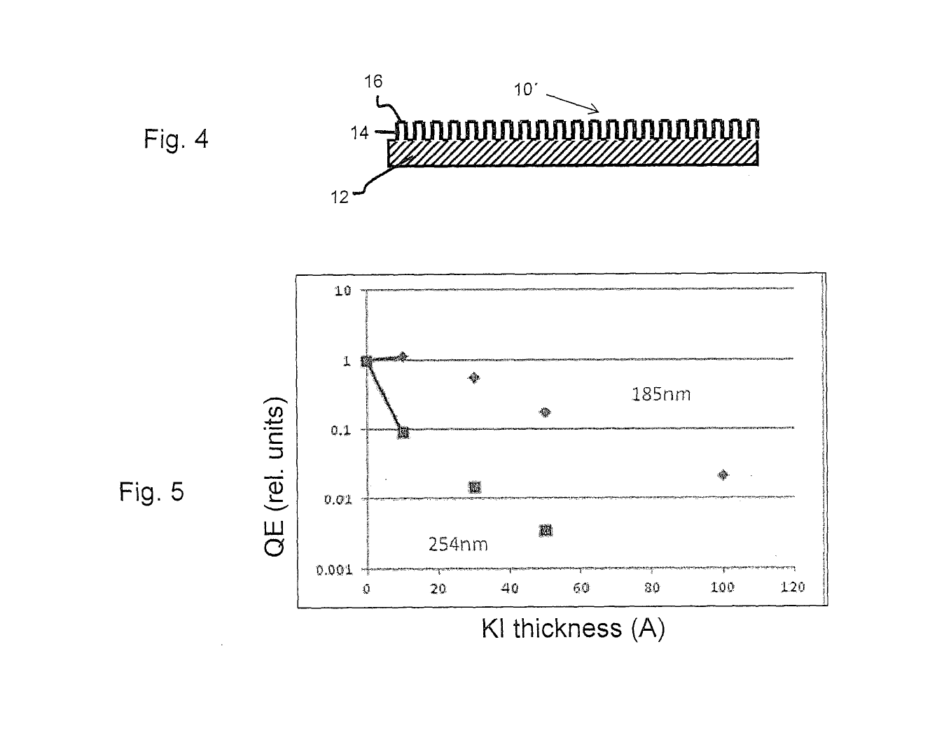

FIG. 4 is a schematic cross-sectional view of a detector device according to another embodiment of the present invention, with a columnar CsI photoconversion structure and KI electron filtering layer;

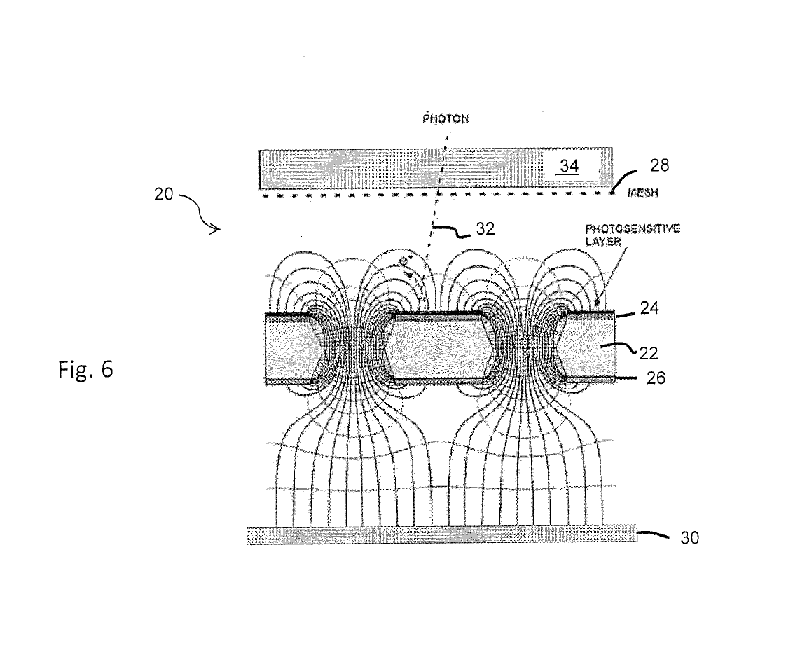

FIG. 5 is a diagram showing the quantum efficiency of the detector device with the columnar structure of FIG. 4 as a function of the thickness of the electron filtering layer;

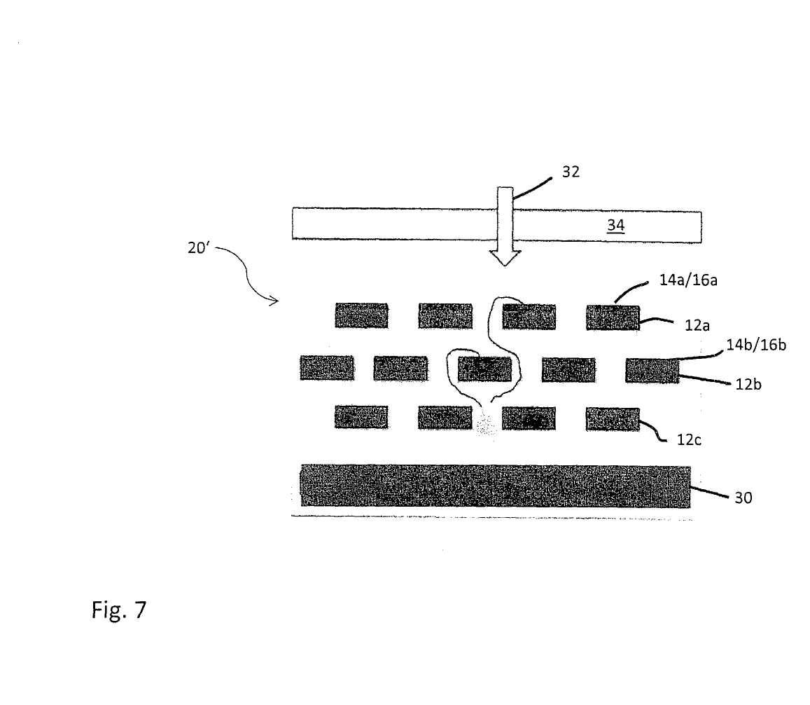

FIG. 6 is a schematic cross-sectional view of a GEM-type detector configuration in which the present invention may be employed;

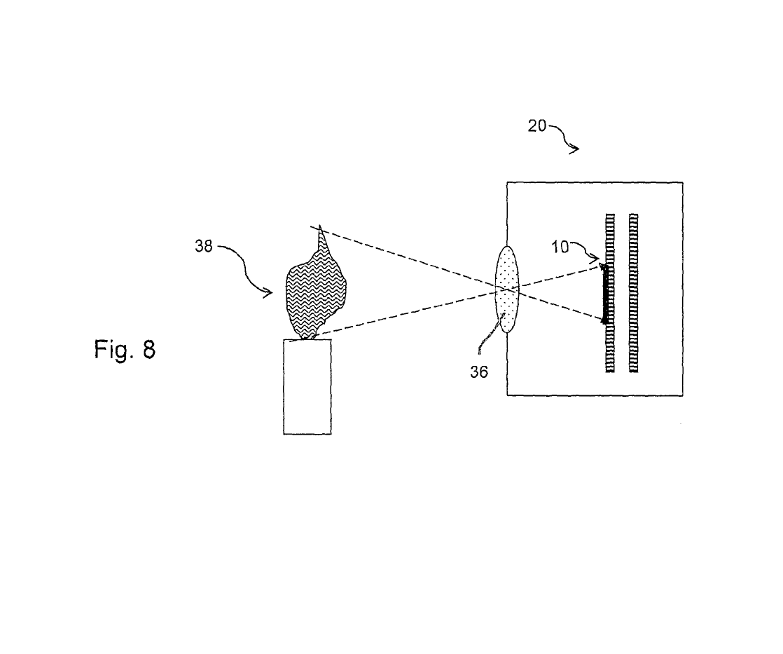

FIG. 7 is a schematic cross-sectional view of a GEM-type detector configuration with cascaded amplification electrodes having misaligned throughholes according to an embodiment of the present invention;

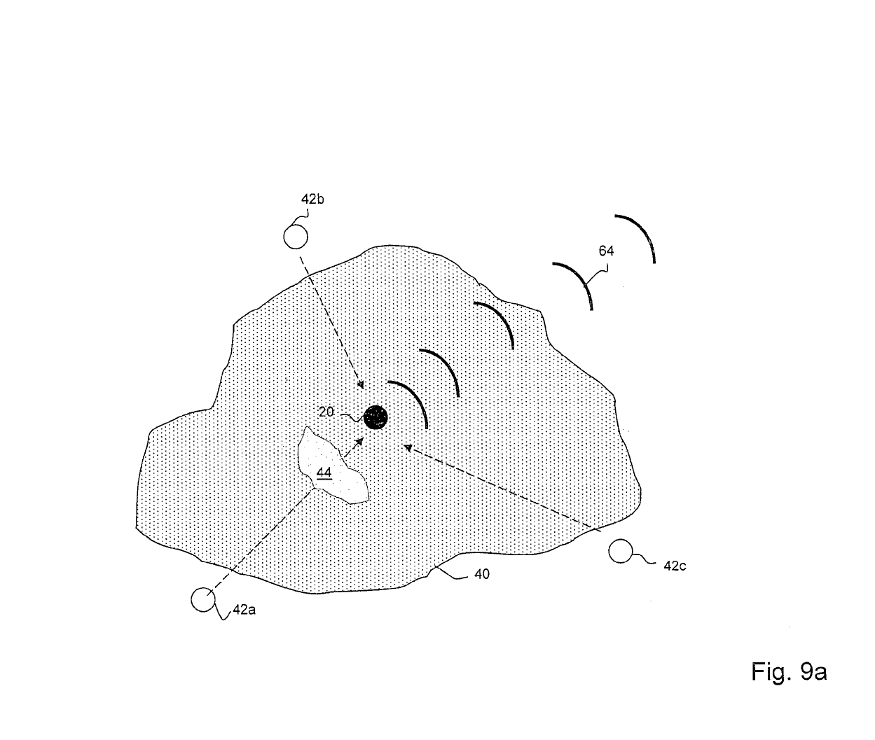

FIG. 8 is a schematic cross-section of a detector configuration according to an embodiment of the present invention, with focusing means for determining the location of a UV light source;

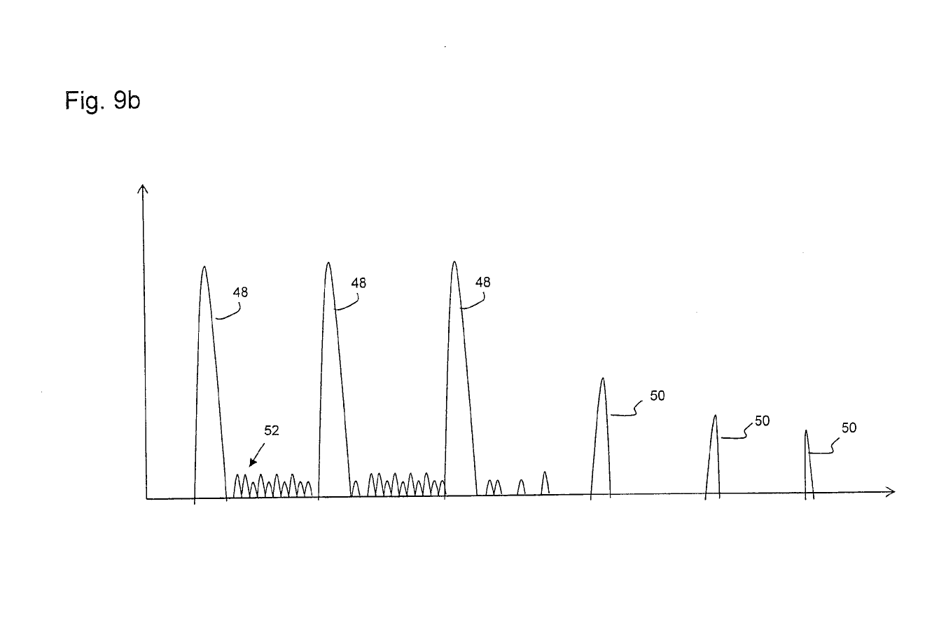

FIG. 9a is a schematic drawing illustrating a method for smoke detection that employs a UV detector according to an embodiment of the present invention; and

FIG. 9b shows signals that may be collected when operating a combined smoke and flame detector according to an embodiment of the present invention.

FIG. 1 is a schematic cross-sectional view of a UV sensor pad 10 according to the present invention. The sensor pad 10 comprises a substrate 12, which may be a metallic substrate or a semiconductor substrate. The substrate 12 may be formed at a thickness of typically in the range of 50 nm to several mm, depending on the application.

A photoconversion layer 14 is formed directly on the substrate 12. The photoconversion layer 14 may be formed of a semiconductor material. Alkali metal halides, such as CsI, are known to be very suitable for photoconversion. As an alternative, CsTe or SbCs photoconversion layers may likewise be employed. These materials are known to have a photon sensitivity that is several orders of magnitude higher than for metallic photocathodes. The reason is that the semiconductor structures, unlike metals, do not comprise free electrons in the bulk substrate, and hence these photoconversion layers do not suffer from lossy electron-electron collisions. In the semiconductor substrates, energy losses are mostly due to phonon scattering of the photoelectrons with the lattice, but in this case the energy loss per interaction is much smaller. Hence, photoelectrons from much deeper regions of the semiconductor device can reach the surface with an energy above the electron affinity. The photoconversion layer 14 may be provided at a thickness of typically between 200 nm and 1000 nm, and can form a large sensitive area, such as 40 cm×60 cm.

However, as explained with reference to the state of the art above, semiconductor photocathodes such as CsI or CsTe are very sensitive to light in the visible spectrum, which leads to strong background noise in outdoor applications.

The inventors found that these problems can be addressed by forming a thin electron filtering layer 16 directly on the photoconversion layer 14. The electron filter layer 16 can be formed from semiconductor materials such as ethyl ferrocene, KI, or NaI. Alternatively, thin metal layers may also be employed. By suitably choosing the material and the thickness of the electron filtering layer 16, photoelectrons at small energies (corresponding to long wavelengths of the incident radiation) can be efficiently filtered out, whereas photoelectrons of higher energies can penetrate the electron filtering layer 16 almost unhindered.

The conversion process is schematically illustrated in FIG. 1. Incident photons of energy E=h·ν, wherein ν denotes the frequency of the incident radiation and h denotes Planck's constant pass through the electron filtering layer 16 and generate photoconversion electrons in the photoconversion layer 14, such as the photoelectron denoted by e− in FIG. 1a. If the photoelectron e− has an energy larger than the electron affinity E_{apc} of the photoconversion layer 14, it may penetrate into the electron filtering layer 16. Among the electrons that reach the electron filtering layer 16, those photoelectrons with relatively low energy (corresponding to small frequencies of the incident radiation) will be filtered out in the electron filtering layer 1, 6, and only electrons having a kinetic energy E_{cr} or higher can penetrate through the electron filtering layer 16 and can be detected as free photoelectrons.

In general, any conventional means for detecting and analyzing the free photoelectrons may be employed in the context of the present invention. These means are not shown in FIG. 1, so to keep the presentation simple and focused. However, an exemplary configuration comprising electron amplification and electron detection will later be described in more detail with reference to FIG. 6.

The critical energy E_{cr} which constitutes the minimal kinetic energy that photoelectrons need to have to penetrate the electron filter layer 16 serves as a filtering threshold and can be tuned with a suitable choice of the material of the electron filtering layer 16 and by suitably choosing its thickness. This energy bound corresponds to a threshold value for the wavelengths of the incident photons: Photons with a wavelength lower than the threshold value can produce photoelectrons that are capable of penetrating through the electron filtering layer 16 and can be detected, whereas electrons from a photoconversion of longer wavelengths of said incident radiation are selectively filtered out. Hence, the detector configuration according to the present invention serves as a filter which cuts the sensitivity of the photoconversion layer 14 to long wavelengths, but only slightly affects the sensitivity to short wavelengths. This allows to filter out background noise from the visible spectrum of the sun or other light sources, whereas radiation in the ultraviolet spectrum can be efficiently detected.

If one uses a photoconversion layer 14 with an electron affinity E_{apc}, then the electron filtering layer 16 should be chosen with an electron affinity E_{af}>E_{apc}. In this case, low-energy photoelectrons are filtered out, but a photoelectron extracted from the photoconversion layer 14 can penetrate through the electron filtering layer 16 if the electron filtering layer 16 is sufficiently thin.

The inventors found that an electron filtering layer 16 in a thickness range of between 20 Å and 100 Å is well-suited to filter out long wavelengths above 250 nm to 270 nm, while it only slightly affects the detector sensitivity to shorter wavelengths.

FIG. 2a is a diagram showing measurement values for the ratio of generated photoelectrons and incident photons (sometimes termed “quantum efficiency”) as a function of the incident wavelength for a detector configuration according to an embodiment of the present invention in which ethyl ferrocene (EF) is used as an electron filtering layer 16 on CsI as a photoconversion layer 14. In the example of FIG. 2a, the thickness of the photoconversion layer 14 was 400 nm and the electron filtering layer 16 was chosen at 30 Å.

For comparison, FIG. 2a also shows the dependence of the quantum efficiency on the wavelength for a conventional metallic photocathode (lower graph in FIG. 2a), and for a photocathode comprising CsI as a photoconversion layer, but without an additional electron filtering layer (upper graph in FIG. 2a). The corresponding detector configurations of these comparative examples are shown in FIGS. 2b and 2c, respectively. In the configuration of FIG. 2b, the photoelectrons are generated directly in the metallic photocathode 18 in response to incident radiation with energy E=h·ν, and are injected with kinetic energy Eₖ. The configuration of FIG. 2c corresponds to the configuration in FIG. 1, just without the electron filtering layer 16. Hence, the photoelectrons are emitted directly from the photoconversion layer 14 with kinetic energy Eₖ.

As can be taken from FIG. 2a, the quantum efficiency decreases towards longer wavelengths (low energies) in all three cases. In the configuration of FIG. 2c employing a CsI photoconversion layer, the quantum efficiency is generally much higher than for the metallic photocathode of FIG. 2b. This is because a photoelectron generated in the metallic photocathode 18 may easily and quickly lose its kinetic energy in electron-electron collisions, and hence only photoelectrons created in the vicinity of the metal surface have a significant probability to escape. In contrast, in semiconductors such as CsI the loss due to electron-electron collisions is negligible, and the dominant energy loss is through phonon scattering interaction with the lattice. However, the energy loss per interaction is much smaller for phonon scattering than for electron-electron scattering, and thus photoelectrons from much deeper regions of the photoconversion layer 14 can reach the surface with an energy above the electron affinity.

As can further be taken from FIG. 2a, the quantum efficiency of the inventive detector configuration employing an electron filtering layer 16 lies in between the values of the comparative examples and is almost as high as in the comparative example of FIG. 2c for short wavelengths. However, photoelectrons corresponding to long wavelengths above 280 nm are efficiently filtered out, and the quantum efficiency drops to the values that would be expected from a metallic photocathode, such as in the comparative example of FIG. 2b.

FIG. 2d shows a similar comparison of the wavelength dependence of the quantum efficiency, but employing KI rather than EF as an electron filtering layer 16 in the configuration of the present invention. As can be taken from the graphs, the same filtering of long wavelength ranges can be achieved.

FIG. 3 illustrates the quantum efficiency in relative units as a function of the thickness of the KI electron filtering layer 16 in the configuration of FIG. 1, for two different wavelengths (254 nm and 185 nm). As can be taken from FIG. 3, a filtering layer 16 with a thickness in the range between 50 Å and 80 Å allows a clear separation of short wavelengths in the UV range that shall be preserved and long wavelengths in the visible spectrum that should preferably be filtered out. This detector configuration can be used as solar-blind sensor for ultraviolet light, such as for flame detection.

The inventors found that some electron filtering layers 16, such as ethyl ferrocene, contribute to the photoelectric effect alongside the photoconversion layer 14, and thus further enhance the quantum efficiency and the sensitivity to short wavelengths. This is another advantage of the detector configuration according to the present invention.

The inventive technique does not impose any limitation on the size of the sensitive area, and hence flat panels with a sensitive area of 40 cm×60 cm or even larger may be covered with the photoconversion layer 14 and electron filtering layer 16 according to the present invention. Compared to conventional techniques that rely on filters and are hence limited in size, this may serve to further increase the sensitivity to UV light.

As an additional advantage, the detector configuration according to the present invention does not rely on photosensitive vapors or gases, and hence can be operated in a wide temperature interval. Tests have been conducted successfully between −200° C. and +80° C.

The configuration of FIG. 1 shows a sensor pad with a photoconversion layer 14 and electron filtering layer 16 with a smooth surface and relatively uniform thickness. However, the invention is not so limited and may also comprise sensor pads with nonuniform or structured surfaces.

An exemplary embodiment with a columnar CsI photoconversion layer 14 formed on the substrate 12 is shown schematically in FIG. 4. An electron filtering layer 16 made from KI extends on and in between the columns of the photoconversion layer 14.

The inventors found that the configuration of FIG. 4 is particularly suitable to filter out long wavelength ranges. FIG. 5 shows a corresponding diagram of the quantum efficiency as a function of the thickness of the electron filtering layer 16 again, for two different values of the incident wavelength (185 nm and 265 nm).

Compared to the smooth and uniform sensor pad of FIG. 1, the filter cutoff becomes even sharper, as can be taken from a comparison of FIG. 5 with the corresponding quantum efficiency shown in FIG. 3.

In the configuration of FIG. 4, the columns are rectangular or cylindrical in shape and extend at regular intervals on the surface of the substrate 12. The height of the columns may amount to 200 μm, with a width of 3 μm and a height in the range of 180-220 μm. The mean spacing between neighboring columns is 1 μm. However, these are mere examples, and columnar structures of other dimensions or other types of uneven surface structures may likewise be employed in the context of the present invention. There is a well developed technique to produce such structures and they are used as scintillators in some commercial devices, for example in mammographic plates.

FIG. 6 illustrates how the present invention may be employed in a GEM-type detector configuration 20. Detectors of this type are well-known for applications in high energy physics and medical technology, and are described in further detail in A. Bressan et al., Nucl Phys. B proceedings supplement 78 (1999) 389. Detectors of this type are characterized by an amplification structure comprising a thin foil, such as a Kapton foil 22 sandwiched between first and second amplification electrodes 24, 26. Throughholes are formed and extend through the foil 72, first electrode 24 and second electrode 26 at regular intervals, as illustrated in FIG. 6. When a voltage is applied between the first electrode 24 and second electrode 26, an intense electric field is generated inside the throughholes. The field line configuration is illustrated schematically in FIG. 6. Typical dimensions of the throughholes are in the range of 50-70 μm, and the potential difference between the first electrode 24 and the second electrode 26 may typically amount to 600 V.

In case of a more robust version of GEM called Thick GEM (TGEM)(L. Periale at al., NIM A478, 2002, 377) and also in the case of a spark resistant Thick GEM called RETGEM (R. Oliveira et al., NIM A576,207,362), the hole diameter can be chosen at 0.5 mm, pitch 0.8 mm and the detector thickness 0.5-0.8 mm. For these detectors a typical voltage between the electrodes 24 and 26 is in the interval 600-1000V

The throughholes in the detector structure serve as amplification gaps in which primary (photo) electrons can be accelerated to sufficiently large speeds to induce an avalanche multiplication by ionizing gas molecules within the throughholes. Part of the positive ions created by the impact ionization process are drawn towards a mesh electrode 28, whereas part of the electron cloud resulting from the avalanche process is accelerated in the opposite direction and towards a collection or readout electrode 30.

In conventional applications, the GEM-detector is usually filled with a detector gas, such as a mixture of argon and methane, in which incident high energetic particles generate the primary electrons that are then amplified and detected. In contrast to the conventional design, the detector configuration shown in FIG. 6 comprises a UV sensor pad 10 as described above with reference to FIG. 1 or 4, with a photoconversion layer formed on the first electrode 24 and a filtering layer 16 provided on the photoconversion layer 14. The first electrode 24 may hence serve as the substrate 12. The photoconversion layer 14 and the electron filtering layer 16 may be formed on the first electrode 24 by means of standard semiconductor manufacturing techniques. Photons incident on the UV sensor pad 10 will generate photoelectrons in the photoconversion layer 14, which may generate free electrons e− that pass the filtering layer 16 (provided their energy is sufficiently large) and are then amplified in the throughholes and can be detected on the readout electrode 30. The path 32 of an incident photon entering the detector through a detector window 34 is illustrated in FIG. 6 with a dashed line.

All these detectors (GEMs, TGEMs, RETGEMs) can be used in cascade mode when two or more GEMs or TGEMs or RETGEMs are operating in tandem in order to reach high gas gains necessary to detect single photoelectrons, as will now be described with reference to FIG. 7.

The detector configuration of FIG. 7 generally corresponds to the detector configuration of FIG. 6. However, instead of a single amplification structure 22 a plurality of substrates 12a, 12b and 12c extend in parallel and spaced apart from another between the readout electrode 30 and the window 34. Photoconversion layers 14a and 14b are provided on the two uppermost substrates 12a and 12b, respectively. Electron filtering layers 16a and 16b are formed on the photoconversion layers 14a and 14b, respectively.

The materials and properties of the substrates 12a, 12b, and 12c, photoconversion layers 14a, 14b, and filtering layers 16a, 16b correspond to those described above with reference to the previous embodiments, in particular with respect to the embodiment of FIG. 6, and hence a detailed description will be omitted.

Throughholes are formed in the first substrate 12a, second substrate 12b, and third substrate 12c in such a way that in the throughholes in the neighboring substrates 12a, 12b and 12b, 12c are misaligned relative to one another.

This configuration allows the detector to operate in a cascade mode. Incident photons 32 impinge either on the uppermost (first) photoconversion layer 14a or on the photoconversion layer 14b extending on the (second) substrate 12b underneath. The generated photoelectrons that pass through the filtering layer 16a and 16b, respectively, are then accelerated consecutively in at least two throughholes on their way towards the readout plate 30. A trajectory of two photoelectrons generated in the first photoconversion layer 14a and in the second photoconversion layer 14b, respectively and the formation of a corresponding electron avalanche is schematically indicated in FIG. 7.

In the configuration of FIG. 7, no photoconversion layer 14 or filtering layer 16 is formed on the lowermost (third) substrate 12c, since this substrate is not directly exposed to incident photons 32.

FIG. 7 shows a configuration with three electrodes 12a, 12b, and 12c extending in parallel between the readout plate 30 and the window 34. However, configurations with any number of cascaded electrodes are within the scope of the present invention. All of these electrodes, or at least a part thereof may be provided with photoconversion layers and filtering layers according to the present invention.

As illustrated schematically in FIG. 8, focusing means such as lenses 36 or blinds may be provided in the window 34 of the detector device according to the present invention so as to focus the incident light from a flame 38 or some other UV light source onto the UV sensor pad 10. The use of lenses 36 allows to resolve a direction and/or angle of the incident UV light, even if the UV source 38 is located far away from the sensor pad 10. A precise localization of the UV source 38 even over large distances is possible.

Compared to conventional detectors that rely on photosensitive vapors, the configuration of the present invention has the additional advantage that photoelectrons are generated localized on the UV sensor pad 10 rather than delocalized across the entire travel path of the incident photons. This avoids parallax effects that typically occur in photosensitive vapors. As a result, UV sources 38 such as flames can be localized with even higher accuracy.

When operated in conjunction with one or several UV sources positioned in the vicinity of the detector device, the detector structure according to the present invention can also be applied for the detection of smoke. A method for detecting smoke is schematically illustrated in FIG. 9a, and is based on the realization that smoke attenuates UV light, so that smoke may be detected based on a decrease in the number of incident UV photons.

As shown in FIG. 9a, the detector 20 may be placed in the center of a monitoring area 40, such as an office space or an assembly hall. A plurality of pulsed UV sources 42a, 42b, 42c may be arranged along the boundaries of the smoke monitoring area 40 and may direct pulsed UV light in the direction of the detector 20. The UV light from the pulse sources 42a, 42b, 42c will hence be detected in the detector 20 in the same way as described above in conjunction with the detection of flames, and will provide pulsed signals in the readout electronics.

Assume now that a pocket of smoke 44 forms in some part of the monitoring area 40, as indicated in FIG. 9a. The smoke 44 will attenuate the UV signal from at least one of the pulsed UV sources, such as UV source 42a, and this attenuation will be detected in the detector 20. If this happens, the detector 20 may send a signal, such as a wireless alarm signal 46, to a smoke surveillance unit, and counter measures may be initiated.

Usually, a fire involves both smoke and flames, and the detector 20 can detect both of them due to the different nature of signals associated with these effects. This is illustrated in the schematic diagram of FIG. 9b, which shows UV pulses 48 generated by a pulsed UV source 42a in comparison with attenuated UV pulses 50 and signals 52 as they may be produced by open fire. As can be taken from FIG. 9b, UV pulses 48 occur at regular intervals, and are typically much larger in amplitude than signal 52 generated by flames. An attenuation due to smoke will usually lead to a decrease in amplitude of the pulsed signals as illustrated for signals 50, but their periodicity will not change. This allows to clearly attribute the regular pulses to the UV sources 42a to 42c, even if the pulses are attenuated due to smoke. A smoke alarm may be triggered if the amplitude of the UV pulses 48 falls below a predetermined threshold value.

On the other hand, a fire alarm may be triggered if additional UV signals 52 are detected that lack the periodicity of the UV pulses 48. Hence, the detector 20 according to the present invention can detect both smoke and fire with a high degree of reliability.

The description of the preferred embodiments and the drawings merely serve to illustrate the invention and the beneficial effects it achieves, but should not be understood to imply any limitation. The scope of the invention is to be determined solely by means of the appended claims.

### REFERENCE SIGNS

10, 10′ UV sensor pad
12; 12a-12c substrate of sensor pad 10
14; 14a, 14b photoconversion layer
16; 16a, 16b electron filtering layer
18 metallic photocathode
20, 20′ GEM-type detector
22 Kapton foil
24 first electrode
26 second electrode
28 mesh electrode
30 collection/readout electrode
32 path of incident photon
34 window
36 UV lens
38 UV source, flame
40 monitoring area
42a, 42b, 42c pulsed UV sources
44 pocket of smoke
46 wireless alarm signal
48 UV pulses
50 attenuated UV pulses
52 UV signals generated by flames

1. A detector device for detecting ultraviolet radiation, comprising:
a substrate;
a photoconversion layer formed on said substrate, said photoconversion layer adapted to convert incident ultraviolet radiation into photoelectrons by means of the photoelectric effect; and
a filtering layer formed on said photoconversion layer, said filtering layer being adapted to selectively filter out electrons from a photoconversion of long wavelengths of said incident radiation.

2. The device according to claim 1, wherein said filtering layer has an electron affinity that is larger than an electron affinity of said photoconversion layer.

3. The device according to claim 1, wherein said filtering layer is formed at a thickness of no larger than 100 Angstrom, preferably no larger than 50 Angstrom, in particular no larger than 20 Angstrom.

4. The device according to claim 1, wherein said filtering layer comprises KI and/or NaI and/or ethylferrocene.

5. The device according to claim 1, wherein said photoconversion layer comprises a semiconductor material.

6. The device according to claim 1, wherein said photoconversion layer comprises an alkali metal halide, in particular CsI.

7. The device according to claim 1, wherein said photoconversion layer comprises CsTe and/or SbCs.

8. The device according to claim 1, wherein said photoconversion layer is formed with an even surface.

9. The device according to the claim 1, wherein said photoconversion layer comprises an uneven surface, in particular a columnar surface structure.

10. The device according to claim 1, further comprising an amplification unit adapted to amplify said electrons passing through said filtering layer, in particular by means of avalanche amplification.

11. The device according to claim 1, wherein throughholes are formed in said substrate, said photoconversion layer, and said filtering layer, said throughholes for amplifying said electrons passing through said filtering layer, in particular by means of avalanche amplification.

12. The device according to claim 1, comprising a plurality of substrates extending spaced apart from one another, wherein a photoconversion layer and/or a filtering layer according to any of the preceding claims are formed on each said substrate.

13. The device according to claim 12, wherein throughholes are formed in at least part of said substrates, said photoconversion layers, and said filtering layers, wherein at least part of said throughholes in neighboring substrates are misaligned with respect to one another.

14. The device according to claim 1, further comprising focusing means for focusing said ultraviolet radiation onto said substrate.

15. The device according to claim 1, further comprising a vacuum chamber in which said substrate is placed.

16. The device according to claim 1, further comprising:
at least one light source emitting ultraviolet radiation, said light source being adapted to emit said ultraviolet radiation towards said substrate;
an electron detection unit adapted to detect and/or analyze said electrons passing through said filtering layer; and
an analyzation unit coupled to said electron detection unit and adapted to derive from said detected electrons a variation in the amount of incident ultraviolet radiation.

17. Use of the device according to claim 1 to detect ultraviolet radiation incident on a surface of said device.

18. Use of the device according to claim 1 to detect fire or smoke from a variation in the amount of ultraviolet radiation incident on a surface of said device.

19. A method for detecting ultraviolet radiation, comprising the steps of:
providing a substrate;
providing a photoconversion layer on said substrate, said photoconversion layer adapted to convert incident ultraviolet radiation into photoelectrons by means of the photoelectric effect;
providing a filtering layer formed on said photoconversion layer, said filtering layer being adapted to selectively filter out electrons emanating from a photoconversion of long wavelengths of said incident radiation;
detecting and/or analyzing said electrons passing through said filtering layer; and
determining from said detected electrons the presence of ultraviolet radiation incident onto said substrate.

20. The method according to claim 19, further comprising a step of amplifying said electrons prior to detecting and/or analyzing said electrons, in particular by means of an avalanche amplification.

21. The method according to claim 19, further comprising a step of focusing said ultraviolet radiation onto said substrate.

22. The method according to claim 19, further comprising the steps of:
providing at least one light source emitting ultraviolet radiation, said light source being adapted to shine said ultraviolet radiation onto said substrate; and
determining from said detected electrons a variation in the amount of incident ultraviolet irradiation.
